(19) United States
(12) Patent Application Publication
(10) Pub. No.: US 2016/0375282 A1
(43) Pub. Date: Dec. 29, 2016

(54) STEP UNIT WITH FALL ARREST CAPABILITY

(71) Applicant: Glenn Sailer, Escondido, CA (US)

(72) Inventor: Glenn Sailer, Escondido, CA (US)

(21) Appl. No.: 15/263,128

(22) Filed: Sep. 12, 2016

Related U.S. Application Data
(63) Continuation-in-part of application No. 14/811,713, filed on Jul. 28, 2015.
(60) Provisional application No. 62/059,148, filed on Oct. 2, 2014.

(51) Int. Cl. A62B 35/00; E06C 9/02

(52) U.S. Cl. CPC A62B 35/0068; E06C 9/02

(57) ABSTRACT

A step unit with fall arrest capability is provided for use in climbing a utility structure. The step unit includes a rod member and a step member. The rod member includes a first rod, a second rod and a connecting portion to form a shape of substantially a letter L. The step member has a shape of a generally hollow cylinder with a bore longitudinally formed therethrough, the step member including a loop section providing substantially a D-shaped opening for use as an anchorage of a fall arrest system. The first rod is configured to be inserted through the bore of the step member and a hole of the utility structure, while the second rod is positioned flush against an opposite side of the utility structure, pointing toward the ascending direction. The step unit may further include a plate member to enhance stability.

### CROSS REFERENCE

This U.S. patent application is a continuation-in-part of the U.S. patent application Ser. No. 14/811,713, filed on Jul. 28, 2015, which claims the benefit of U.S. provisional patent application Ser. No. 62/059,148, filed on Oct. 2, 2014.

### BACKGROUND

The present invention broadly relates to safety equipment for climbing utility structures, such as utility towers and utility poles.

Fall arrest is one form of fall protection, regulations of which are specified by OSHA to prevent individuals working at height from fall injury. Personal fall arrest is one type of fall arrest, and a personal fall arrest system typically includes at least the following four key elements: anchorage, body wear, connector, and deceleration device. An anchorage is a secure point, often referred to as a tie-off point, for attachment to a structural part such as a rebar, I-beam, scaffolding and the like. A body wear is typically a body harness worn by the worker. A deceleration device has a mechanism to dissipate a substantial amount of energy and force associated with a fall arrest event. Examples of deceleration device include a rope grab, shock-absorbing lanyard, fall limiter, self-retracting lifeline and the like, one end of which can be coupled to a body wear. A connector is a device used to couple the other end of the deceleration device to the anchorage, such as a cross-arm strap, beam anchor, snap-hook, carabiner and the like. Each of these parts of a personal fall arrest system is typically required to sustain a minimum of 5,000 pounds per worker.

A utility tower is typically constructed to have threaded holes, which are to be engaged with threaded step rungs. Such a step rung is typically formed to have a shape of a bolt, i.e., an elongated solid cylinder with a threaded end portion, which is fastened with a fastener such as one or more nuts to secure the engagement with the threaded hole. A utility pole is typically constructed to have holes where step rungs are to be inserted. The end portion of such a step rung may include a hook or be properly shaped for securing the step rung through the hole.

Utility workers climb utility structures, such as utility towers and utility poles, for repair, construction, maintenance and other purposes, with a variety of safety equipment. Conventional techniques addressing fall arrest in climbing a utility tower or pole include use of an independent component, such as a carabiner, climbing clip, hook and the like, to couple the deceleration device to the step rung installed with the structure. Other examples include a step rung integrated with an attachment to allow the climber to hook in a hook or clip installed at the end of the deceleration device, or to weave a climbing cable or rope around the step rung. However, these conventional techniques often fail to meet the requirement of supporting a load of 5,000 pounds or greater per worker. Therefore, there is a need for an easily installable step rung with reliable fall arrest capability. Furthermore, while new constructions of utility structures can be configured with safety equipment installed at the onset of construction, it is often necessary to retrofit old utility structures with new safety equipment to meet increasingly stringent safety requirements.

### BRIEF DESCRIPTION OF THE DRAWINGS

FIGS. 1A, 2A, 3A and 4A illustrate a top view, a side view, a front view and a back view of a rod member, respectively, of a step unit according to an embodiment.

FIGS. 1B, 2B, 3B and 4B illustrate a top view, a side view, a front view and a back view of a step member, respectively, of a step unit according to an embodiment.

FIG. 5 illustrates a perspective view of the step unit having the rod member and the step member assembled.

FIG. 6 illustrates an example of configuration of the step unit installed with a utility structure.

FIGS. 7A and 7B illustrate an example pair of the support plate and the corresponding step member, showing the perspective view from front and the perspective view from back, respectively.

FIGS. 8A, 8B, 8C and 8D illustrate an example of the support plate, showing the front view, back view, top view and bottom view, respectively.

FIGS. 9A, 9B and 9C illustrate an example configuration of the present step unit including the rod member, the step member and the support plate installed with a utility structure, showing the side view, top view and bottom view, respectively.

FIG. 10 illustrates an example configuration of an assembly of the present step unit having the rod member, the step member and the support plate, showing the perspective view without the utility structure.

### DETAILED DESCRIPTION

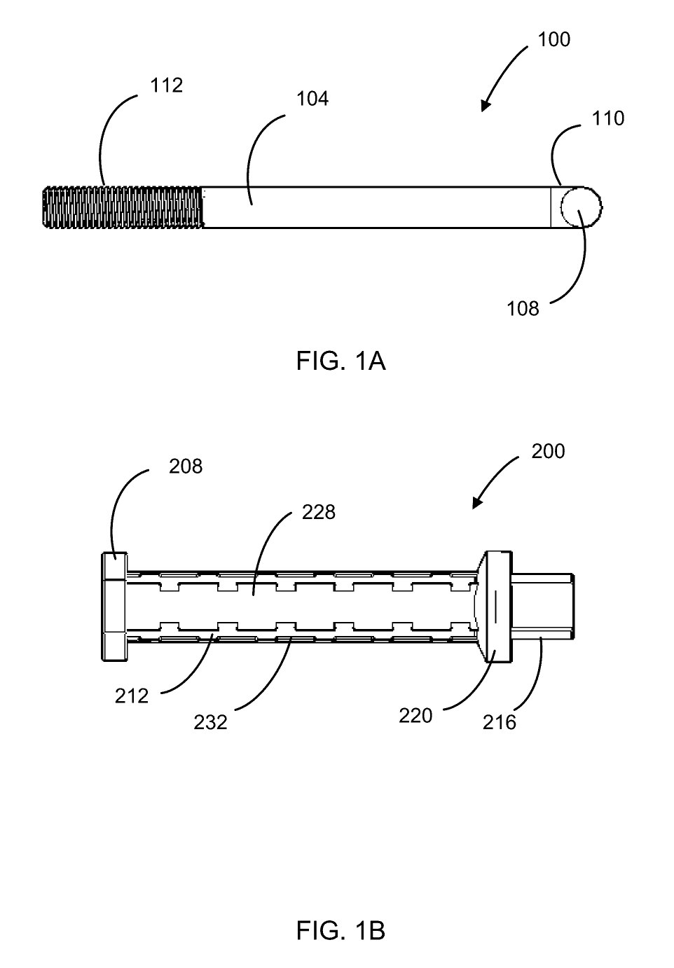

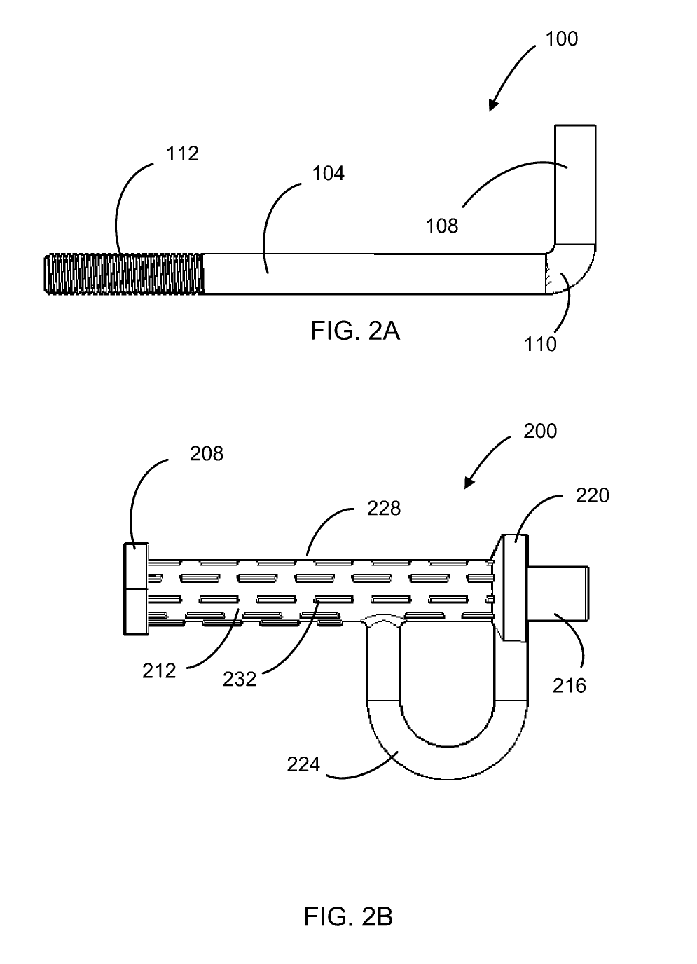

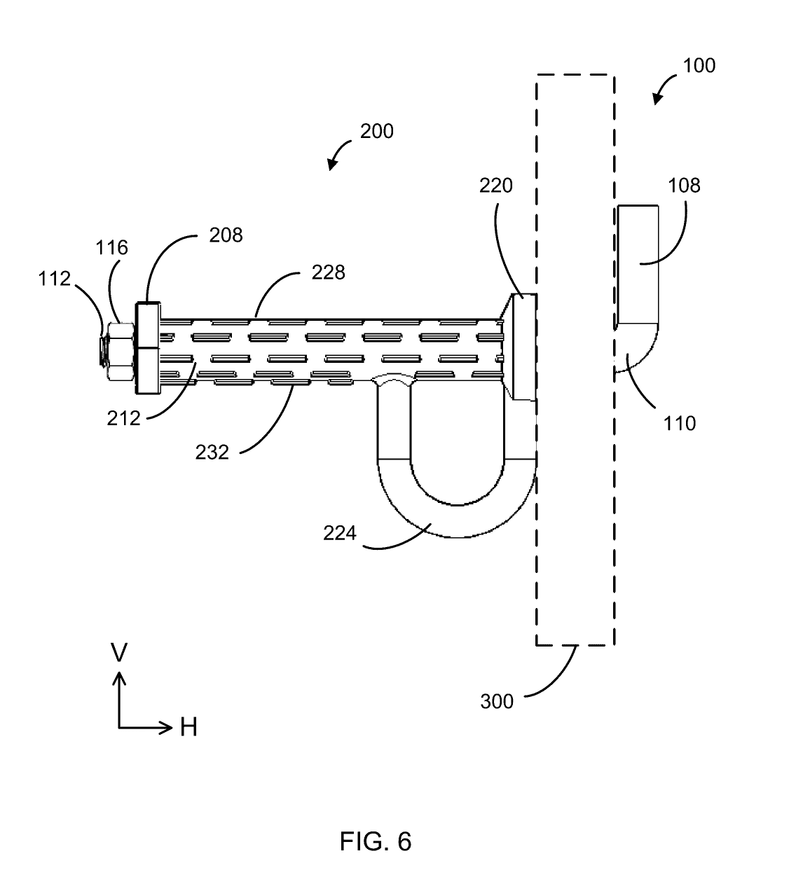

A step unit with fall arrest capability is provided according to an embodiment, for use in climbing a utility structure, such as a utility tower or a utility pole. The present step unit includes two separate members: a rod member 100 and a step member 200. FIGS. 1A, 2A, 3A and 4A illustrate a top view, a side view, a front view and a back view of the rod member 100, respectively. FIGS. 1B, 2B, 3B and 4B illustrate a top view, a side view, a front view and a back view of the step member 200, respectively. FIG. 5 illustrates a perspective view of the step unit having the rod member 100 and the step member 200 assembled. The rod member 100 includes a first rod 104 elongated in the longitudinal direction, a second rod 108 elongated in the transversal direction and a connecting portion 110 connecting the first rod 104 and the second rod 108. The connecting portion 110 is integrally attached to one end portion of the first rod 104 and to one end portion of the second rod 108 with an angle of substantially 90°, whereby the rod member 100 is formed to have the first rod 104 and the second rod 108 substantially orthogonal to each other, resembling a shape of substantially a letter L with the rounded corner provided by the connecting portion 110. In this example, the length of the second rod 108 is configured to be shorter than that of the first rod 104. The other end potion of the first rod 104 has a threaded surface, providing a thread section 112.

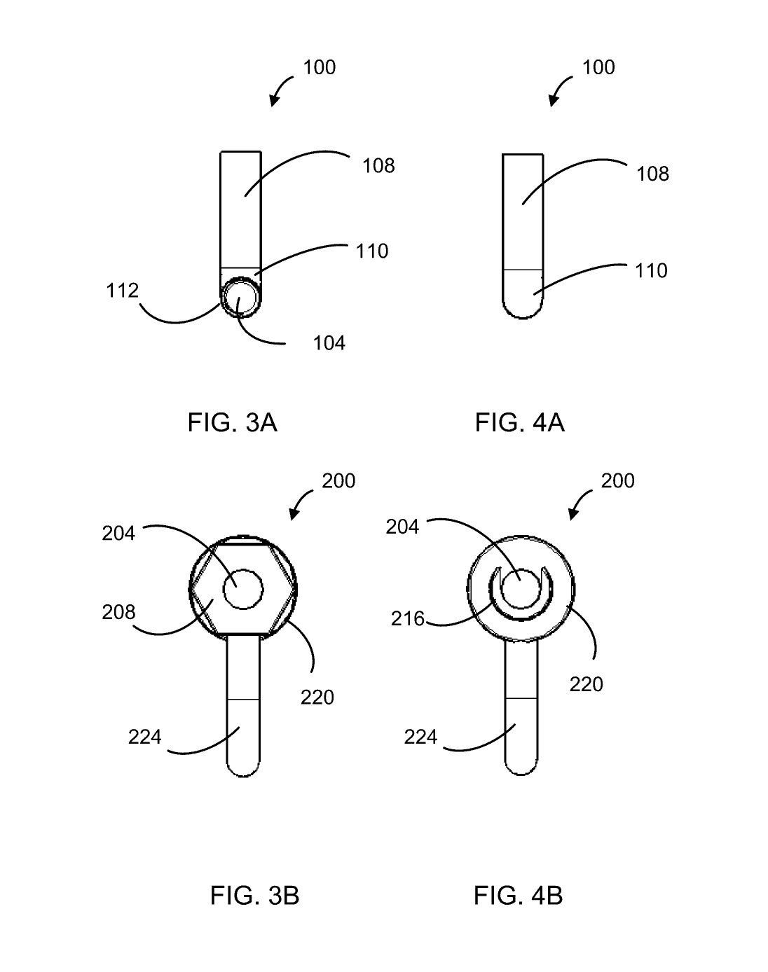

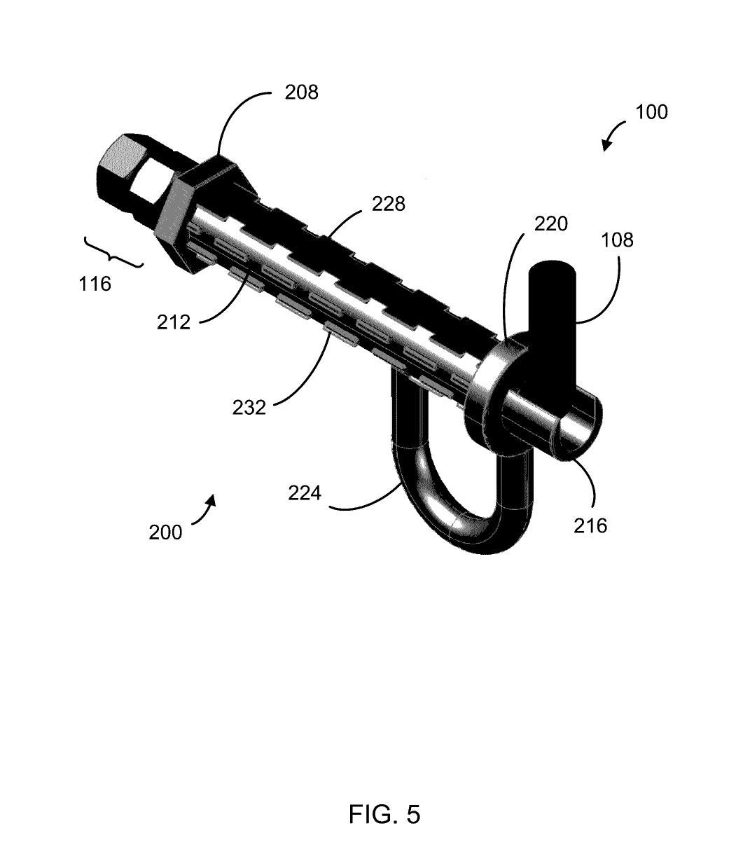

The step member 200 is configured for use as a step for a utility worker to step on for climbing a utility structure. The step member 200 is configured to have a shape of a generally hollow cylinder having an internal cylindrical surface defining a bore 204 longitudinally formed therethrough, as seen in FIGS. 3B and 4B. The diameter of the bore 204 is configured to be slightly larger than the diameter of the first rod 104, so that the first rod 104 can be smoothly inserted through the bore 204, as illustrated in FIG. 5. The step member 200 includes a head section 208 formed at one end portion. The head section 208 has a cross-sectional shape along the transversal direction, which is orthogonal to the longitudinal direction of the step member 200. The cross-sectional shape of the head section 208 may be a hexagon, a square, a rectangle, an oval, a circle, or any other shape. The step member 200 has a shank section 212 contiguous to the head section 208, wherein the shank section 212 is configured to have a length sufficient for a foot of a climbing worker to step on. That is, the length of the shank section 212 is configured to be large enough to accommodate the width of the shoe the worker is wearing. The transversal dimension of the head section 208 is configured to be larger than that of the shank section 212, so as to prevent a foot of the worker from sideway slippage. The step member 200 has a guide section 216 at the end portion opposite to the head section 208. The guide section 216 has a shape of substantially a partial cylinder with an opening formed longitudinally and facing upward, as illustrated in FIGS. 4B and 5. The bottom portion of the internal surface defining the bore 204, formed through the head section 208 and the shank section 212, extends continuously through the guide section 216, providing a longitudinally formed groove for longitudinally guiding an object therein.

The step member 200 is further configured to provide fall arrest capability by including a flange section 220 and a loop section 224. The flange section 220 is integrally attached around the circumference of the cylindrical shape of the step member 200 between the shank section 212 and the guide section 216. The loop section 224 has a shape of generally an open loop. One end portion of the loop section 224 is integrally connected to the flange section 220, while the other end portion of the loop section 224 is integrally connected to the shank section 212, thereby providing an opening defined by the loop section 224 and the part of the shank section 212 between the two end portions of the loop section 224, resembling a letter D in this example. Thus, the loop section 224 is configured for use as an anchorage of a fall arrest system in the present step unit.

The shank section 212 has a first surface and a second surface. The first surface includes a flat surface 228 that is formed opposite to the loop section 224, and extends longitudinally between the head section 208 and the flange section 220. When the present step unit is installed with a utility structure, the flat surface 228 can be oriented to face toward substantially the ascending direction to provide a flat standing platform for the worker. The second surface of the shank section 212 has multiple ridges 232 formed in a pattern between the head section 208 and the flange section 220. Each of the multiple ridges 232 is formed longitudinally along the length of the step member 200. The height, width and length of each ridge 232 as well as the pattern of the multiple ridges 232 can be configured to provide suitable friction to a vertical force exerted by a gripping hand or a slipping foot, thereby providing enhanced prevention from fall.

In the assembled configuration illustrated in FIG. 5, the first rod 104 of the rod member 100 is inserted through the bore 204, while the second rod 108 is positioned to protrude vertically from the longitudinal opening of the guide section 216. The longitudinal opening of the guide section 216 can be positioned to face the direction opposite to the loop section 224. In the example illustrated in FIG. 5, two nuts are provided as fastening parts 116, collectively called a fastener herein, to provide fastening options depending on the fastening strength needed for each use. One or both of the nuts can be engaged with the end portion of the thread section 112 protruding from the head section 208 through the bore 204, to secure the rod member 100 and the step member 200 to a utility structure. One or more washers may be added to enhance the fastening strength.

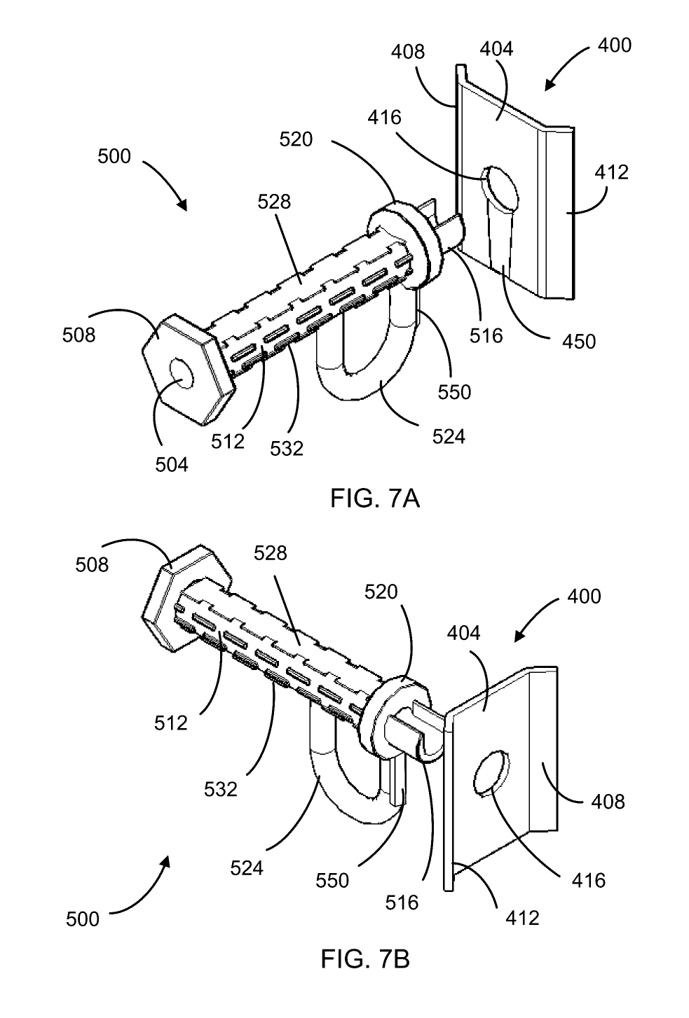

FIG. 6 illustrates an example configuration of the present step unit installed with a utility structure 300. A portion of the utility structure 300 around a hole formed therein (not shown) is illustrated with dashed lines in FIG. 6. The horizontal direction and the vertical direction are denoted as H and V, respectively, in FIG. 6. In this configuration, the present step unit is installed with the utility structure 300, which is constructed to stand along the vertical direction, to have the part of the first rod 104 and the guide section 216 penetrating substantially horizontally through the hole of the utility structure 300, while the second rod 108 is positioned flush against the opposite side of the utility structure 300, pointing upward substantially in the vertical direction. The first rod 104 is inserted through the bore 204 longitudinally formed in the step member 200. Thus, the step member 200 is placed around the first rod 104 with the flange section 220 flush against the utility structure 300 and the loop section 224 pointing downward substantially in the vertical direction. One nut 116 is used in this example to fasten the end portion of the thread section 112 protruding from the head section 208 through the bore 204, to secure the rod member 100 and the step member 200 to the utility structure 300. The step member 200 may spin around its cylindrical axis unless it is held at the position while the nut 116 is turned around the thread section 112 for the fastening. To prevent the spinning, the head section 208 may be grabbed by a wrench, a hand, or other means to hold the step member 200 during the fastening process.

In the configuration illustrated in FIG. 6, the loop section 224 is positioned to point downward substantially in the vertical direction, i.e., the direction opposite to the ascending direction, and the flat surface 228 is oriented to face upward substantially in the vertical direction, i.e., the ascending direction. As mentioned earlier, a deceleration device has a mechanism to dissipate a substantial amount of energy and force associated with a fall arrest event. Examples of deceleration device include a rope grab, shock-absorbing lanyard, fall limiter, self-retracting lifeline and the like, one end of which can be coupled to a body harness the worker is wearing. The other end of the deceleration device may include a connector, such as a cross-arm strap, beam anchor, snap-hook, carabiner and the like, which can be used for engagement with the loop section 224 of the present step unit. The load testing is typically conducted to ensure the sustainability of a minimum of 5,000 pounds.

As illustrated in FIGS. 1-6, the loop section 224 is integrally attached at one end portion of the shank section 212, which is the root portion of the step unit when installed with the utility structure 300. The loop section 224 is provided at the root portion because the torque exerted by the load to the step unit is smaller when the loop section 224 is at the root portion than when it is at the other end portion close to the head section 208, thereby providing better durability and strength.

The step unit may be made of cast alloy steel, for example. Various sections in the rod member 100, except for the fastening parts 116, may be integrally formed by welding, molding, or other suitable processing technique. Similarly, various sections in the step member 200 may be integrally formed by welding, molding, or other suitable processing technique.

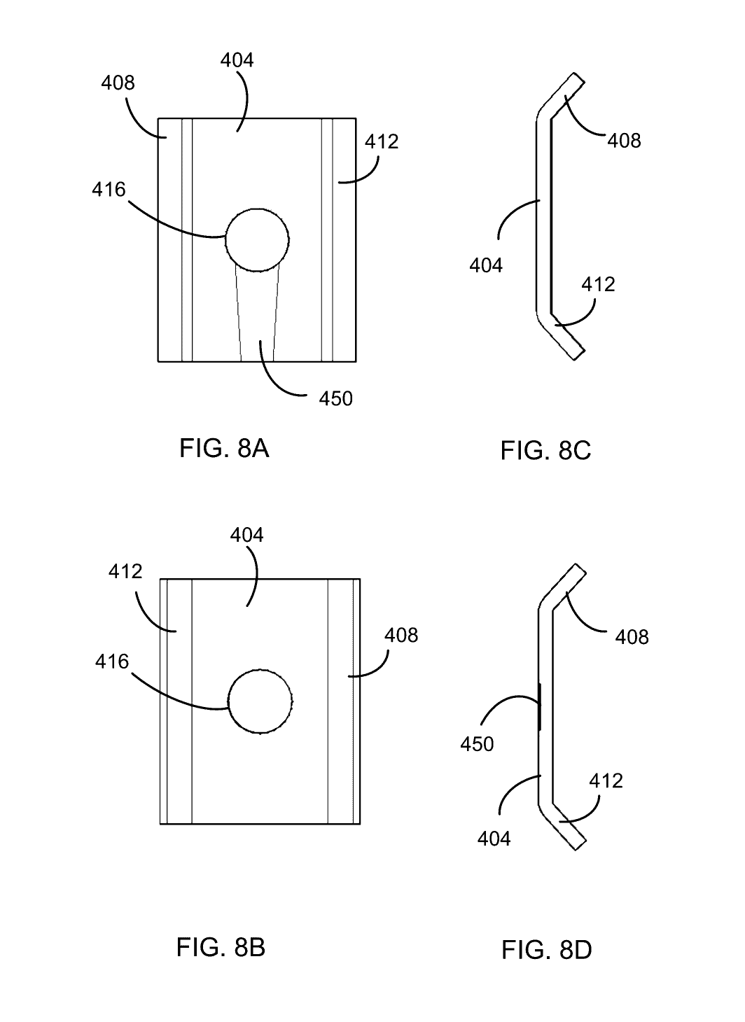

The step unit may be configured to include a support plate to enhance the stability. FIGS. 7A and 7B illustrate an example pair of the support plate 400 and the corresponding step member 500, showing the perspective view from front and the perspective view from back, respectively. Similar to the step member 200 illustrated in FIGS. 1B, 2B, 3B and 4B, the step member 500 has a head section 508, a shank section 512, a guide section 516, a flange section 520, a loop section 524, a flat surface 528, and multiple ridges 532. The step member 500 is configured to have a shape of a generally hollow cylinder having an internal cylindrical surface defining a bore 504 longitudinally formed therethrough, as seen in FIG. 7A, similar to the bore 204 shown in FIGS. 3B and 4B. The diameter of the bore 504 is configured to be slightly larger than the diameter of the first rod 104, so that the first rod 104 can be smoothly inserted through the bore 504.

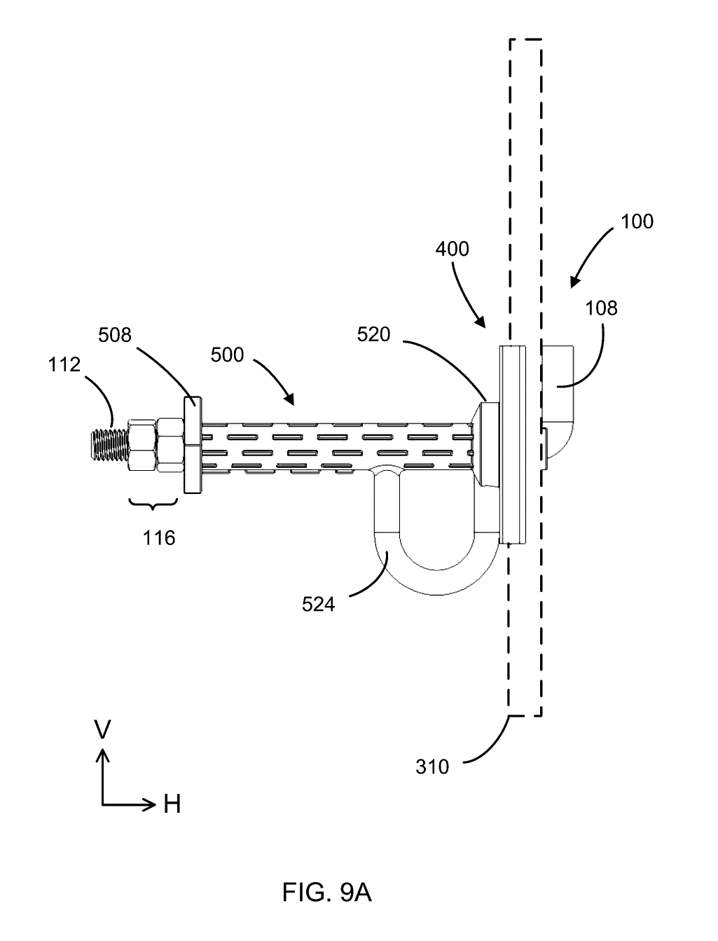

FIGS. 8A, 8B, 8C and 8D illustrate an example of the support plate 400, showing the front view, back view, top view and bottom view, respectively. This example is the same support plate 400 illustrated in FIGS. 7A and 7B, where the perspective view from front and the perspective view from back are shown, respectively. In this example, the support plate 400 comprises a first plate 404, a second plate 408 and a third plate 412, wherein the second plate 408 is contiguously attached to one side edge of the first plate 404 and the third plate 412 is contiguously attached to the opposite side edge of the first plate 404, wherein each of the second plate 408 and the third plate 412 is positioned to form an obtuse angle with respect to the first plate 404. The degree of the obtuse angle can be predetermined based on the curvature of the utility structure, such as a utility pole, with which the step unit is installed. Therefore, in this example, the second plate 408 and the third plate 412 resemble a pair of wings to the first plate 414, pointing toward the back. In another example, the support plate 400 can be made flat, without having the wing sections, to flush against a substantially flat surface, for the case when the surface of the utility structure is substantially and/or locally flat. An opening 416 is formed around the center of the first plate 404. The opening 416 in this example has a shape of a round hole. The shape of the opening 416 can be circular, oval or another. The shape and dimensions of the opening 416 are configured to allow the guide section 516 of the step member 500 to smoothly penetrate therethrough. A depression 450 may be formed on the front surface of the first plate 404, channeling the opening 416 and a bottom edge of the first plate 404. A protrusion 550 may be correspondingly formed on the side of the loop section 524 of the step member 500, contiguously to the flange section 520. The shape and dimensions of the depression 450 and the shape and dimensions of the protrusion 550 can be configured to fit each other, thereby engaging with each other for enhanced stability with reduced rotational slippage.

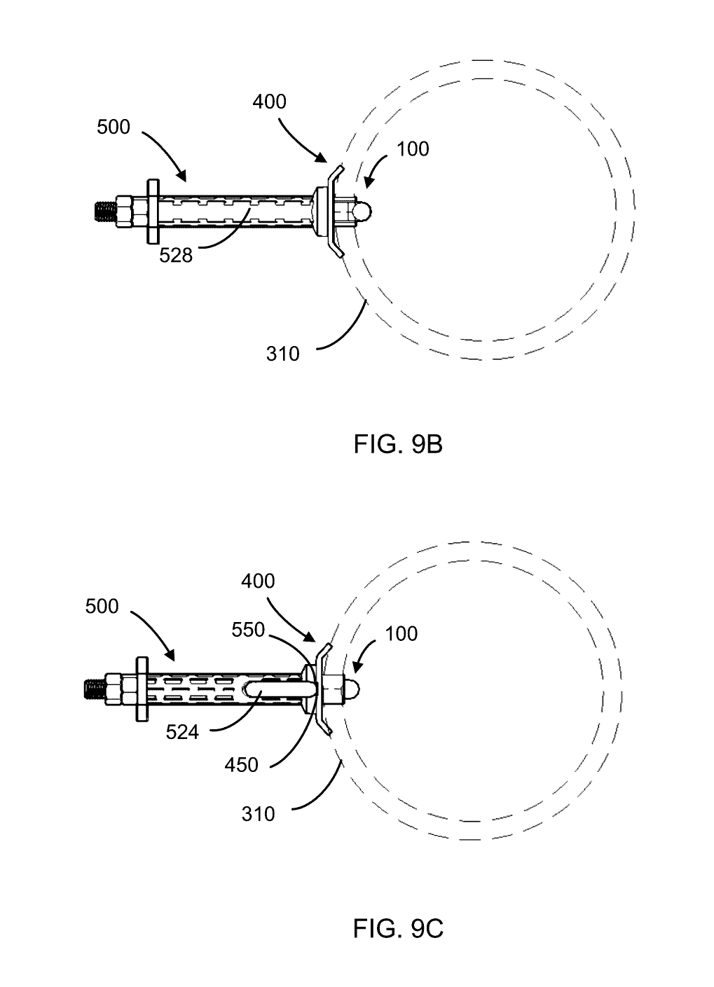

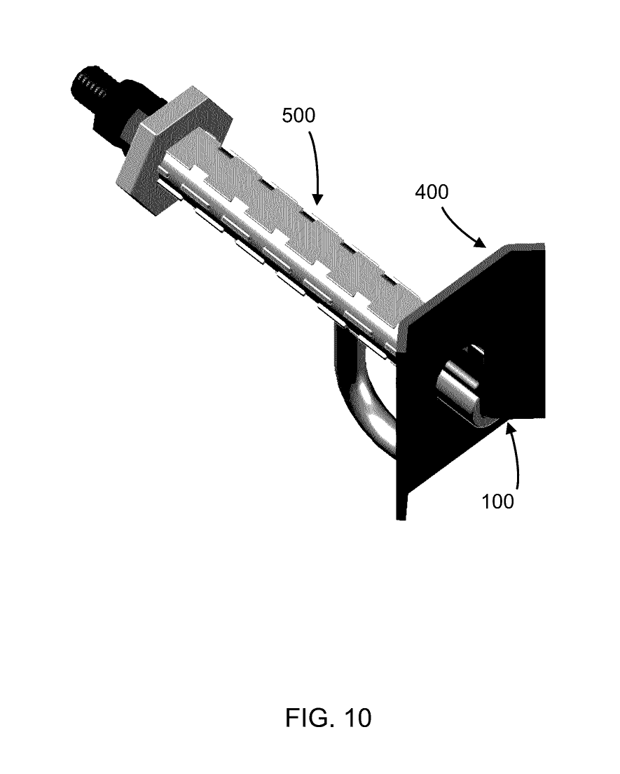

FIGS. 9A, 9B and 9C illustrate an example configuration of the present step unit including the rod member 100, the step member 500 and the support plate 400 installed with a utility structure 310, showing the side view, top view and bottom view, respectively. A portion of the utility structure 310 around a hole formed therein (not shown) is illustrated with dashed lines in these figures. FIG. 10 illustrates an example configuration of an assembly of the present step unit having the rod member 100, the step member 500 and the support plate 400, showing the perspective view without the utility structure.

The horizontal direction and the vertical direction are denoted as H and V, respectively, in FIG. 9A. In this configuration, the present step unit is installed with the utility structure 310, which is constructed to stand along the vertical direction, to have the part of the first rod 104 and the guide section 516 penetrating substantially horizontally through the hole of the utility structure 310, while the second rod 108 is positioned flush against the opposite side of the utility structure 310, pointing upward substantially in the vertical direction. The first rod 104 is inserted through the bore 504 longitudinally formed in the step member 500 and through the opening 416 of the support plate 400. The step member 500 is positioned around the first rod 104 with the loop section 524 pointing downward substantially in the vertical direction. The step member 500 may spin around its cylindrical axis unless it is held at the position while the nut 116 is turned around the thread section 112 for the fastening. To prevent the spinning, the head section 508 may be grabbed by a wrench, a hand, or other means to hold the step member 500 during the fastening process.

As illustrated in FIGS. 9A-9C, the support plate 400 is configured to be interposed between the flange section 520 and the utility structure 310, so that the utility structure 310 is sandwiched between the support plate 400 and the second rod 108. Two nuts 116 are used in this example to fasten the end portion of the thread section 112 protruding from the head section 508 through the bore 504, to secure the rod member 100, the step member 500 and the support plate 400 to the utility structure 310. In this configuration, the contact surface area of the support plate 400 with the utility structure 310 is larger than the contact surface area when only the flange section 520 or 220 is placed to flush against the utility structure 310, as illustrated in FIG. 6. Thus, the use of the support plate 400 provides more stability than using only the flange section 520 or 220 for securing the present step unit to a utility structure. A pair of the depression 450 in the support plate 400 and the protrusion 550 on the side of the loop section 524 of the step member 500 may be formed. The stability of the support plate 400 with respect to the flange section 520 can be enhanced by this pair, wherein the shapes and dimensions of the pair are configured to fit each other to engage with each other, thereby reducing the rotational slippage therebetween. In this example illustrated in FIGS. 9A-9C, the second plate 408 is contiguously attached to one side edge of the first plate 404 and the third plate 412 is contiguously attached to the opposite side edge of the first plate 404, wherein each of the second plate 408 and the third plate 412 is positioned to form an obtuse angle with respect to the first plate 404. The degree of the obtuse angle can be predetermined based on the curvature of the utility structure 310, such as a utility pole. In the case where the surface of the utility structure 310 is substantially and/or locally flat, the support plate 400 can be configured to be substantially flat, for example, by having only the first plate 404 with large dimensions. The support plate 400 can be thus configured to optimize the contact surface area with a utility structure.

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be exercised from the combination, and the claimed combination may be directed to a subcombination or a variation of a subcombination.

What is claimed is:

1. A step unit with fall arrest capability for use in climbing a utility structure, the step unit comprising:
a rod member comprising a first rod, a second rod and a connecting portion, wherein the connecting portion is integrally attached to one end portion of the first rod and to one end portion of the second rod to form the rod member having a shape of substantially a letter L, and wherein the other end portion of the first rod has a threaded surface; and
a step member having a shape of a generally hollow cylinder having an internal cylindrical surface defining a bore longitudinally formed therethrough, wherein a diameter of the bore is configured for the first rod to be smoothly inserted through, the step member comprising:
a head section at one end portion;
a guide section at the other end portion;
a shank section contiguous to the head section;
a flange section integrally attached between the shank section and the guide section; and
a loop section, one end portion of which is integrally attached to the flange section and the other end portion of which is integrally attached to the shank section, to provide substantially a D-shaped opening defined by the loop section and a part of the shank section between the two end portions of the loop section.

2. The step unit of claim 1, wherein
the step member is configured to be positioned around the first rod with the flange section flush against a side of the utility structure and the loop section pointing toward a direction opposite to an ascending direction, and
the first rod is configured to be inserted through the bore of the step member and a hole of the utility structure, while the second rod is positioned flush against an opposite side of the utility structure, pointing toward the ascending direction,
for installing the step unit with the utility structure.

3. The step unit of claim 2, further comprising:
a fastener for fastening an end portion of the threaded surface of the first rod protruding from the head section through the bore, to secure the rod member and the step member to the utility structure.

4. The step unit of claim 3, wherein
the head section is configured to be grabbed by a wrench, a hand or other means to hold the step member while the fastener is turned around the threaded surface for the fastening.

5. The step unit of claim 1, wherein
the shank section has a first surface including a flat surface that is formed opposite to the loop section, and extends longitudinally between the head section and the flange section, to provide a flat standing platform for a worker climbing the utility structure.

6. The step unit of claim 1, wherein
the shank section has a second surface including a plurality of ridges longitudinally formed in a pattern, wherein height, width and length of each ridge and the pattern are configured to provide friction to a vertical force exerted by a gripping hand or a slipping foot of a worker climbing the utility structure.

7. The step unit of claim 1, wherein
the guide section is configured to have a shape of substantially a partial cylinder with an opening formed longitudinally and facing a direction opposite to the loop section, wherein a bottom portion of the internal surface defining the bore, formed through the head section and the shank section, extends continuously through the guide section, to provide a longitudinally formed groove for longitudinally guiding an object therein.

8. The step unit of claim 1, further comprising:
a plate member comprising one or more plates and having an opening, wherein
the plate member is configured to be interposed between the flange section and the utility structure,
the step member is configured to be positioned around the first rod to have the loop section pointing toward a direction opposite to an ascending direction, and
the first rod is configured to be inserted through the bore of the step member, the opening of the plate member and a hole of the utility structure, while the second rod is positioned flush against an opposite side of the utility structure, pointing toward the ascending direction,
for installing the step unit with the utility structure.

9. The step unit of claim 8, further comprising:
a fastener for fastening an end portion of the threaded surface of the first rod protruding from the head section through the bore, to secure the rod member, the step member and the plate member to the utility structure.

10. The step unit of claim 8, wherein
the plate member comprises a first plate having the opening and a depression formed on a surface, the depression channeling the opening and a bottom edge of the first plate, and
the step member includes a protrusion formed on a side of the loop section,
wherein shapes and dimensions of the depression and the protrusion are configured to fit each other to engage with each other to reduce rotational slippage therebetween.

11. The step unit of claim 8, wherein
the plate member comprises a first plate, a second plate and a third plate, wherein the second plate contiguously attached to one side edge of the first plate and the third plate contiguously attached to the opposite side edge of the first plate,
wherein each of the second plate and the third plate is positioned to form an obtuse angle with respect to the first plate, and wherein a degree of the obtuse angle is predetermined based on a curvature of the utility structure.
